(19) United States
(12) Patent Application Publication
(10) Pub. No.: US 2017/0259497 A1
(43) Pub. Date: Sep. 14, 2017

(54) METHODS OF MODULATING POLYMER RHEOLOGY FOR ADDITIVE MANUFACTURING

(71) Applicant: XEROX CORPORATION, Norwalk, CT (US)

(72) Inventors: Rachel PRESTAYKO, Hamilton (CA); Sarah J. VELLA, Milton (CA); Carolyn MOORLAG, Mississauga (CA); Barkev KEOSHKERIAN, Thornhill (CA); C. Geoffrey ALLEN, Waterdown (CA)

(73) Assignee: XEROX CORPORATION

(21) Appl. No.: 15/065,492

(22) Filed: Mar. 9, 2016

(51) Int. Cl. B29C 67/00; C09D 7/12; C08K 3/04; C09D 171/00

(52) U.S. Cl. CPC B29C 67/0055; C09D 171/00; C09D 7/1216; C08K 3/04; B29C 67/0077; B29K 2105/162

(57) ABSTRACT

A method includes adding about 5 weight percent to about 25 weight percent of carbon nanotubes to a crystalline or semi-crystalline polymer to form a composite and forming a filament or particles from the composite, the filament or particles having a size suitable for use in additive manufacturing, in the absence of the carbon nanotubes a melt viscosity of the crystalline or semi-crystalline polymer is below 100 Pa·s, preventing its use in additive manufacturing. The filament or particles comprising carbon nanotubes can be used in methods of additive manufacturing.

### BACKGROUND

The present disclosure relates to methods and materials used in additive manufacturing. In particular, the present disclosure relates to methods of modulating the rheology of crystalline and semi-crystalline polymers with carbon nanotube additives rendering them suitable for additive manufacturing processes.

Additive manufacturing (AM or 3D printing) has increased in recent years as an easy, cost effective means to create real parts from 3D computer-aided design (CAD) data. 3D printing encompasses numerous additive manufacturing technologies including PolyJet, Z-Corp 3D Color Prints, Stereolithography (SLA), Selective Laser Sintering (SLS), Direct Metal Laser Sintering (DMLS) and Fused Deposition Modeling (FDM). These manufacturing processes provide custom parts by accurately “printing” layer upon layer of plastic or metal build materials until a 3D form is created.

Thermoplastic polymers are frequently used in the field of additive manufacturing because they possess several material properties suitable for building 3-dimensional objects. For example, upon heating, some of these materials flow as viscous fluids permitting extrusion in a layer by layer process to build objects in three dimensions. Upon cooling, these layers retain their structural integrity as they solidify. One such process that uses this melt flow behavior is fused deposition modeling (FDM) where the thermoplastic material is provided as a filament typically of about 1.75 mm or about 3.00 mm in diameter. During the process filaments are fed through a heated nozzle to deliver to a build platform where the object is printed.

Only a small set of polymer materials exists on the market for FDM including acrylonitrile butadiene styrene (ABS), polylactic acid (PLA), polycarbonate, polyurethane and nylon. These materials exhibit high melt viscosities at extrusion temperatures. While other polymers may be of interest in additive manufacturing many simply do not possess the rheological properties necessary for extrusion and similar additive manufacturing processes. For example, to reduce environmental impact it may be desirable to use polymers that are not petroleum-derived, while ensuring the biodegradability of the final objects. However, many bio-derived polymers do not possess the requisite melt viscosity characteristics. Other polymers may be useful to enhance the compatibility between multiple different material components in a printed object, while still other polymers may be useful to provide lower cost alternatives. Many of these potentially useful polymers suffer from a sharp melt transition to a low viscosity fluid which is not suitable for FDM and similar processes because (1) the polymer cannot be obtained in filament form, and/or (2) there would be little control over material placement during the printing process due to the low viscosity.

### SUMMARY

In embodiments, there are provided methods comprising adding about 5 weight percent to about 25 weight percent of carbon nanotubes to a crystalline or semi-crystalline polymer to form a composite and forming a filament or particles from the composite, the filament or particles having a size suitable for use in additive manufacturing, in the absence of the carbon nanotubes a melt viscosity of the crystalline or semi-crystalline polymer is below 100 Pa·s, preventing its use in additive manufacturing.

In embodiments, there are provided composites comprising about 5 weight percent to about 25 weight percent of carbon nanotubes and a crystalline or semi-crystalline polymer, wherein in the absence of the carbon nanotubes a melt viscosity of the crystalline or semi-crystalline polymer is below 100 Pa·s, preventing its use in additive manufacturing, and wherein the composite has a melt viscosity in a range from about 1000 to about 50000 Pa·s.

In embodiments, there are provided methods of additive manufacturing comprising providing a filament or particle comprising a composite, the composite comprising about 5 weight percent to about 25 weight percent of carbon nanotubes, and a crystalline or semi-crystalline polymer, wherein in the absence of the carbon nanotubes a melt viscosity of the crystalline or semi-crystalline polymer is below about 100 Pa·s, preventing its use in additive manufacturing, and heating the filament or particle as part of an additive manufacturing process.

### BRIEF DESCRIPTION OF DRAWINGS

Various embodiments of the present disclosure will be described herein below with reference to the figures wherein:

FIG. 1A shows an extruded filament of an exemplary polyester without carbon nanotube additives.

FIG. 1B shows an extruded filament of the same exemplary polyester in FIG. 1A with about 10% by weight of composite of multi-walled carbon nanotubes (MWNTs).

FIG. 2 shows a plot of viscosity versus temperature for an exemplary polyester with and without MWNTs.

### DETAILED DESCRIPTION

Embodiments herein provide methods for altering the melt flow properties of low melt viscosity polymers, in particular crystalline and semi-crystalline polymers, through the addition of carbon nanotube additives in order to achieve the processability required for additive manufacturing. Additive manufacturing has been primarily concerned with printing structural features. However, embodiments herein allow for an expanded role of the polymer by integrating polymers with a broader array of functional properties, such as electronic features, in the final printed object. Recent attempts to provide printed objects with conductive properties with existing additive manufacturing materials have only provided low conductivities, generally ranging from about 10⁻³ S/cm to about 2.0 S/cm, or from about 10⁻³ S/cm to about 0.5 S/cm. The mechanical properties of the commercially available materials conductive materials such as acrylonitrile butadiene styrene (ABS) or polylactic acid (PLA), are generally limited and may suffer from, for example, a lack of flexibility. Another factor to consider when developing materials for additive manufacturing is their ability to perform within the operational parameters of existing 3D printing machines. Embodiments herein address one or more of these issues as well as others that will recognized by those skilled in the art.

Embodiments herein provide methods for the modification of polymer melt flow properties through the addition of carbon nanotubes in order to achieve processability for 3D printing applications. In particular, the polymers targeted herein are those not otherwise suitable for conventional additive manufacturing by melt extrusion via, for example, FDM and similar techniques that rely on polymer melting, such as selective laser sintering (SLS). Thus, the methods herein improve the melt flow properties of low melt viscosity polymers via the addition of carbon nanotubes such that they are processable for additive manufacturing technologies. In particular, embodiments herein allow the use of polymer base materials which have a sharp melt transition to a lower viscosity fluid.

In embodiments, there are provided methods comprising adding about 5 weight percent to about 25 weight percent of carbon nanotubes to a crystalline or semi-crystalline polymer to form a composite, and forming a filament or particles from the composite, the filament or particles having a size suitable for use in additive manufacturing, wherein in the absence of the carbon nanotubes a melt viscosity of the crystalline or semi-crystalline polymer is below about 100 Pa·s, preventing its use in additive manufacturing.

In embodiments, the carbon nanotubes (CNTs) are multi-walled carbon nanotubes (MWNTs). In embodiments, the carbon nanotubes are single-walled carbon nanotubes (SWNTs). In embodiments, the carbon nanotubes are double-walled carbon nanotubes (DWNTs). In embodiments, the carbon nanotubes are conducting, semiconducting, or combinations thereof. In embodiments, the carbon nanotubes are conducting. In embodiments, the carbon nanotubes are semi-conducting. In embodiments, the CNTs may be end capped or open.

Those skilled in the art will appreciate that certain benefits conferred by carbon nanotubes may be available via other nanoparticulate additives, such as graphene, buckminsterfullerene and related fullerenes, nanofibers, nanorods, nanocones, nanocapsules, nanostars, nanoflakes and the like. However, CNTs, in particular may impart both exceptional mechanical strength and targeted electrical properties to the composite.

In embodiments, the CNTs may be functionalized by numerous methods known in the art. Functionalization may be achieved by, for example, oxidation. In embodiments, oxidative functionalization may provide CNTs with carboxylic acid functional groups. In embodiments, such carboxylic acid functionalization may be used to covalently bond the CNTs to the crystalline or semi-crystalline polymer matrix. Other known functionalizations can be incorporated in the CNTs including, for example, fluorination.

In embodiments, CNTs may range in diameter from about 1 nm to about 20 nm, or about 1 to about 10 nm, or about 1 to about 5 nm. In embodiments, the CNT may range in length from about 10 microns to about 50 microns.

Embodiments herein are particularly effective for crystalline or semi-crystalline polymers that exhibit sharp melting points and therefore cannot otherwise be processed into filaments for use in, for example, fused deposition modelling and similar additive manufacturing (3D printing) techniques. As used herein, a “sharp melting point polymer” is one that exhibits a melting temperature range that spans about 5° C., or about 1° C., or about 0.5° C. The crystalline or semi-crystalline polymers also exhibit a large viscosity drop upon melting. For example, the viscosity change may result in a viscosity less than about 100 Pa·s, making it incompatible with additive manufacturing processes.

Crystalline or semi-crystalline properties of polymers can be assessed by techniques known to those skilled in the art, including but not limited to, density measurements, calorimetry, x-ray diffraction, and infrared and/or nuclear magnetic resonance spectroscopy. Those skilled in the art will recognize that crystallinity and semi-crystallinity can be a matter of degree. In accordance with embodiments herein, those polymers exhibiting the aforementioned sharp melting points and large viscosity drops are reflect, at least in part, the requisite degree of crystallinity.

In embodiments, the crystalline or semi-crystalline polymer may comprise a copolymer. In embodiments, the crystalline or semi-crystalline polymer may comprise a diblock or triblock copolymer. In embodiments, the copolymer may be an interpolymer, an alternating copolymer, a periodic copolymer, a linear copolymer, a branched copolymer, and the like.

Exemplary polymers that operate in accordance with the composites and methods herein include, without limitation, nylon, polyoxymethylene, polyethylene terephthalate, polybutylene terephthalate, and polytetrafluoroethylene. In embodiments, the crystalline or semi-crystalline polymer is a polyester.

In embodiments, the crystalline or semi-crystalline polymer comprises an ester, such as a polyester. The crystalline or semi-crystalline polyester may be a polyester resin such as detailed in U.S. Pat. Nos. 6,653,435 and 6,780,557, each incorporated herein by reference in its entirety. For example, the crystalline or semi-crystalline polyester may be obtained by polycondensing an alcohol component comprising 80% by mole or more of an aliphatic diol having 2 to 6 carbon atoms, such as 4 to 6 carbon atoms, with a carboxylic acid component comprising 80% by mole or more of an aliphatic dicarboxylic acid compound having 2 to 8 carbon atoms, such as 4 to 6 carbon atoms or 4 carbon atoms. See, for example, U.S. Pat. No. 6,780,557. The aliphatic diol having 2 to 6 carbon atoms may include ethylene glycol, 1,2-propylene glycol, 1,3-propylene glycol, 1,4-butanediol, 1,5-pentanediol, 1,6-hexanediol, neopentyl glycol, 1,4-butanediol, and the like. It is desirable that the aliphatic diol is contained in the alcohol component in an amount of about 80% by mole or more, such as from about 85 to 100% by mole. The alcohol component may also contain a polyhydric alcohol component other than the aliphatic diol having 2 to 6 carbon atoms. Such a polyhydric alcohol component includes a divalent aromatic alcohol such as an alkylene (2 to 3 carbon atoms) oxide adduct (average number of moles added being 1 to 10) of bisphenol A, such as polyoxypropylene (2.2)-2,2-bis (4-hydroxyphenyl) propane and polyoxyethylene (2.2)-2,2-bis(4-hydroxyphenyl) propane; a trihydric or higher polyhydric alcohol component such as glycerol, pentaerythritol and trimethylolpropane; and the like. The aliphatic dicarboxylic acid compound having 2 to 8 carbon atoms includes oxalic acid, malonic acid, maleic acid, fumaric acid, citraconic acid, itaconic acid, glutaconic acid, succinic acid, adipic acid, acid anhydrides thereof alkyl (1 to 3 carbon atoms) esters thereof, and the like. It is desirable that the aliphatic dicarboxylic acid compound is contained in the carboxylic acid component in an amount of about 80% by mole or more, such as from about 85 to 100% by mole. Among them, from the viewpoint of the storage ability of the crystalline polyester, it is desirable that fumaric acid is contained in the carboxylic acid component in an amount of about 60% by mole or more, such as about 70 to 100% by mole. The carboxylic acid component may contain a polycarboxylic acid component other than the aliphatic dicarboxylic acid compound having 2 to 8 carbon atoms. Such a polycarboxylic acid component includes aromatic dicarboxylic acids such as phthalic acid, isophthalic acid and terephthalic acid; aliphatic dicarboxylic acids such as sebacic acid, azelaic acid, n-dodecylsuccinic acid and n-dodecenylsuccinic acid; alicyclic carboxylic acids such as cyclohexanedicarboxylic acid; tricarboxylic or higher polycarboxylic acids such as 1,2,4-benzenetricarboxylic acid (trimellitic acid) and pyromellitic acid; acid anhydrides thereof, alkyl (1 to 3 carbon atoms) esters thereof, and the like.

The crystalline polyester may also be derived from monomers containing an alcohol component comprising a trihydric or higher polyhydric alcohol, and a carboxylic acid component comprising a tricarboxylic or higher polycarboxylic acid compound as detailed in U.S. Pat. No. 6,653,435, incorporated herein by reference in its entirety. The trihydric or higher polyhydric alcohols include sorbitol, 1,2,3,6-hexanetetrol, 1,4-sorbitan, pentaerythritol, dipentaaerythritol, tripentaerythritol, 1,2,4-butanetriol, 1,2,5-pentanetriol, glycerol, 2-methylpropanetriol, 2-methyl-1,2,4-butanetriol, trimethylolethane, trimethylolpropane, 1,3,5-trihydroxymethylbenzene, and the like. Examples of the tricarboxylic or higher polycarboxylic acid compound include 1,2,4-benzenetricarboxylic acid (trimellitic acid), 2,5,7-naphthalenetricarboxylic acid, 1,2,4-naphthalenetricarboxylic acid, 1,2,4-butanetricarboxylic acid, 1,2,5-hexanetricarboxylic acid, 1,3-dicarboxy-2-methyl-2-methylenecarboxypropane, 1,2,4-cyclohexanetricarboxylic acid, tetra(methylenecarboxyl)methane, 1,2,7,8-octanetetracarboxylic acid, pyromellitic acid, Empol timer acid, acid anhydrides thereof, alkyl (1 to 3 carbon atoms) esters thereof, and the like.

The aforementioned crystalline or semi-crystalline polyester materials may be prepared by the polycondensation reactions described in the aforementioned patents.

In embodiments, the crystalline or semi-crystalline polyester material may be derived from a monomer system comprised of an alcohol selected from among 1,4-butanediol, 1,6-hexanediol, and mixtures thereof with a dicarboxylic acid selected from among fumaric acid, succinic acid, oxalic acid, adipic acid, and mixtures thereof. For example, the crystalline polyester may be derived from 1,4-butanediol and fumaric acid, the polyester having a crystallinity of about 25 to about 75%, or about 40 to about 60%.

The crystalline or semi-crystalline polyester may have a melting point of from about 85° C. to about 150° C., such as from about 90° C. to about 140° C. In embodiments, the crystalline or semi-crystalline polymer has a melting temperature less than about 250° C.

In embodiments, there are provided composites comprising about 5 weight percent to about 25 weight percent of carbon nanotubes and a crystalline or semi-crystalline polymer, wherein in the absence of the carbon nanotubes a melt viscosity of the crystalline or semi-crystalline polymer is below about 100 Pa·s, preventing its use in additive manufacturing; and wherein the composite has a melt viscosity in a range from about 1,000 to about 5,0000 Pa·s.

In embodiments, composites comprise about 10 weight percent to about 25 weight percent of carbon nanotubes, or about 10 to about 20 weight percent of carbon nanotubes, or about 15 to about 20 weight percent by weight of the composite.

In embodiments, the composite has a melt viscosity in a range from about 1000 to about 50000 Pa·s.

In embodiments, the composite is formed into a filament having a diameter suitable for fused deposition modeling. In embodiments, the filament diameter is in a range from about 1.65 mm to about 1.85 mm, or about 2.75 mm to about 2.95 mm.

In embodiments, the composite is formed into particles having a size suitable for selective laser sintering. In embodiments, particles for use in selective laser sintering may have an effective average particle diameter in a range from about 10 microns to about 100 microns.

In embodiments, there are provided methods of additive manufacturing comprising providing a filament or particle comprising a composite, the composite comprising about 5 weight percent to about 25 weight percent of carbon nanotubes, and a crystalline or semi-crystalline polymer, wherein in the absence of the carbon nanotubes a melt viscosity of the crystalline or semi-crystalline polymer is below 100 Pa·s, preventing its use in additive manufacturing and heating the filament or particle as part of an additive manufacturing process.

In embodiments, the additive manufacturing process is fused deposition modelling. In embodiments, the additive manufacturing process is selective laser sintering. In embodiments, the heating step is performed by a heating portion of an additive manufacturing apparatus.

Addition of carbon nanotubes to polymers has been indicated to increase the melt viscosity of polymer materials to which they are added. However, this increase in viscosity is also typically accompanied by an increase in processing temperature. This temperature increase can result in the composite material having a processing temperature outside the range of the commercial 3D printers. Where filamentous materials are desired for additive manufacturing processes two parameters render a polymer-CNT composite suitable for use: i) the viscosity should be in a range from about 1,000 Pa·s to about 50,000 Pa·s, and ii) the melting temperature range should be in a range from about 50° C. to about 250° C. Additive manufacturing processes (i.e., 3D printing) have a limited range of temperatures within which to process the polymers while also imposing suitable flow characteristics on the polymer. In embodiments, the base polymer from which carbon nanotube composites are formed may be crystalline or semi-crystalline polymers.

The addition of carbon nanotubes to these sharp melting polymers broadens their melting range and changes their viscosity profile so that they become processable into filaments and can be subsequently printed. Surprisingly, it was found that for these polymers with sharp melting points as the viscosity profile broadened, the temperature difference between the extrusions of the parent polymer and the CNT-composite is very small and low, whereas typical thermoplastic polymers exhibit either i) a change in processing temperature or ii) composite extrusion temperature that is too high (highlighted in Table 1 of Example 4 below).

The following Examples are being submitted to illustrate embodiments of the present disclosure. These Examples are intended to be illustrative only and are not intended to limit the scope of the present disclosure. Also, parts and percentages are by weight unless otherwise indicated. As used herein, “room temperature” refers to a temperature of from about 20° C. to about 25° C.

### EXAMPLES

### Example 1

This Example demonstrates the improved processability of CNT-polymer composites to form filaments, in accordance with embodiments herein.

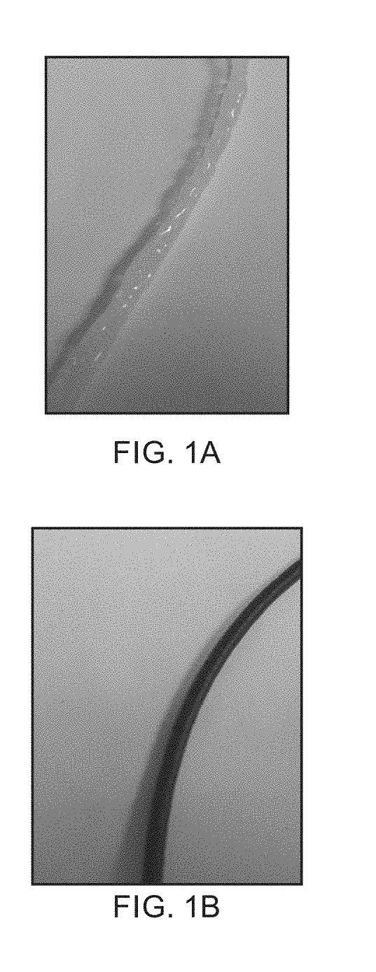

A polyether-ester block copolymer (Dupont Hytrel G3548) was cut into small pellets and melted in a Melt Flow Indexer at 170° C. in order to extrude filament out of a custom designed 2.0 mm diameter die with a 16.96 kg weight. The sharp melt transition to a low viscosity fluid resulted in the inability to form a filament uniform in size and shape as shown in FIG. 1A. The resulting filament had a diameter which ranged from 1.54-3.29 mm.

A composite material comprised of 10 wt % multi-walled carbon nanotubes (MWNT) in the same polyether-ester block copolymer base material was melt mixed at 30 rpm for 30 minutes on a Haake Rheocord twin screw extruder. After removal, it was cryogenically ground and extruded under the same conditions in the Melt Flow Indexer at 170° C. with a 16.96 kg weight out of a 2.0 mm orifice. The filament shown in FIG. 1B retained its cylindrical shape and has a significantly smaller range in diameter from 1.90-2.24 mm. This improvement in extrusion processing from the addition of multi-walled carbon nanotube (MWNT) results in a wider scope of base materials which can be used in 3D printing. Thus, the processability of polymers which exhibit a sharp transition to a low melt viscosity fluid was improved through the addition of carbon nanotubes. This improvement in melt flow properties allows these materials to be utilized for additive manufacturing technologies.

### Example 2

This Example describes the synthesis of copoly(ethylene-sebacate)-copoly(ethylene-5-sulfoisophthalate), a polymer useful in the manufacture of composites in accordance with embodiments herein.

A 1-L Parr reactor equipped with a mechanical stirrer, distillation apparatus and bottom drain valve was charged with Sebacic acid (485.7 g, 2.4 moles), Ethylene glycol (353.6 g, 5.7 moles), Lithium salt of 5-Sulfo-isophthalic acid (49 g, 0.195 mole) and 0.85 g of FASCAT 4100 (Butylstanoic acid) catalyst. The mixture was gradually heated from 150 to 200 degrees centigrade over a 5.5 hour period, wherein water was collected in the distillation receiver. The pressure of the reactor was then gradually reduced to 0.13 mm-Hg and the temperature was gradually heated to 210 degrees centigrade over a three hour period, wherein more water and the excess ethylene glycol was collected in the distillation receiver. A combined total amount of water (40 g) and ethylene glycol (170 g) as collected. The resin was then discharged through the bottom drain valve into a metal container and left to cool to room temperature. DSC indicated a melting point peak of 65.69 degrees centigrade.

### Example 3

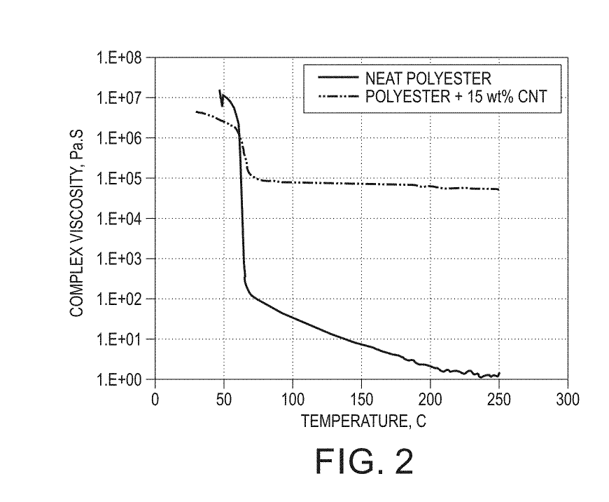

This Example shows the impact of CNTs on melting temperature is shown in Figure FIG. 2 for an exemplary semi-crystalline polyester GS-1062. A composite material consisting of 15 wt % multi-walled carbon nanotubes (Cheaptubes 8-15 nm OD) in semi-crystalline copoly(ethylene-sebacate)-copoly(ethylene-5-sulfoisophthalate) was melt mixed on Haake Rheocord twin screw extruder at 75° C. for 30 min at 30 rpm.

Rheology metrics including complex viscosity, viscous modulus and elastic modulus were determined on a DHR-2 rheometer equipped with a 25 mm parallel plate available from TA Instruments. A temperature sweep was completed by loading samples at 35 to 40° C., equilibrating for five minutes, and subjecting the samples to an oscillating frequency of 6.28 rad/s while heating at a rate of 5° C./min to 250° C. while obtaining readings every 12 s.

### Example 4

In this Example, a Melt Flow Indexer (MFI) was used to heat various materials and then extrude them through a die (orifice diameter=−1.8 mm) using an applied weight of 16.96 kg and gravity.

Extrusion using the MFI generates filaments with average diameters of about 1.78 mm. In this Example, the MFI temperature to make a filament was i) about 70° C. for copoly(ethylene-sebacate)-copoly(ethylene-5-sulfoisophthalate), ii) about 100° C. for a 15 wt % CNT composite with the same polymer base, and iii) about 125° C. to for a 25 wt % CNT composite with the same polymer base. In contrast, as CNT is added to semi-crystalline PCL (Happy Wire Dog LLC, Scottsdale, Ariz.) the viscosity and the extrusion temperature both increase. The extrusion temperature of the 15 wt % CNT in PCL was about 150° C., which is 88° C. higher and at about 20 wt % CNT the temperature required for extrusion is great than 260° C. which is 170° C. higher than the extrusion temperature of native PCL. Moreover, the extruding temperature of 260° C. is not only outside the printing range of a typical 3D FDM printer such as the Makerbot 3D printer (operational range from about 25° C. to about 250° C.), but causes the decomposition of the PCL. Table 1 below shows the changes in processing temperatures upon adding about 20 weight percent CNT to various polymers.

TABLE 1

| | | Processing | |
|---|---|---|---|
| | MFI extrusion | temperature of | |
| | temperature of | 20 wt % CNT in | Δ Processing |
| | native polymer | polymer | Temperature |
| Base Polymer | (° C.) | (° C.) | (° C.) |
| GS-1062 | 70 | 113* | ~45 |
| PCL Instamorph | 90 | 260 | 170 |
| Lubrizol Estane 58315 | 180 | 230 | 50 |
| Poly (styrene-isoprene- | 170 | 260 | 90 |
| styrene) | | | |

*Data point calculated based on a linear fit of actual data.

As indicated by the Examples herein, MFI processing temperatures and differential processing temperatures of the various composites compared to their respective neat polymer resins are not predictable.

CNT composites based on GS-1062 show an unexpected beneficial property with respect to such composites containing relatively higher CNT loadings (i.e., greater than 15 wt % CNT) and such that are able to be processed at relatively lower MFI temperatures.

The MFI processability of GS-1062 composites containing greater than about 20 wt % CNT and at MFI temperatures less than about 150° C. is in stark contrast to other composites containing greater than about 20 wt % CNT which were not processable.

Embodiments herein thus broaden the scope of an entire class of materials that could not be previously employed for additive manufacturing/3D printing. Accessibility of new polymers (via CNT incorporation) in additive manufacturing may provide a variety of advantages, including but not limited to, biocompatibility, eco-friendly character, and reduced costs. Crystalline or semi-crystalline polymers having a melting point that is too sharp to be suitable for 3D printing are effectively made useful by the addition of CNTs which broadens the melting transition, without appreciably changing the onset temperature of the melting, and increases the viscosity sufficiently that filaments can be made. Finally, these materials are processable within the range of melt flow characteristics employed in 3D printers.

Embodiments disclosed herein are merely illustrative, it will be appreciated by those skilled in the art, given the guidance and teaching herein that various alternatives, modifications, variations or improvements may be made, which are intended to be encompassed by the following claims.

What is claimed is:

1. A method comprising:
adding about 5 weight percent to about 25 weight percent of carbon nanotubes to a crystalline or semi-crystalline polymer to form a composite; and
forming a filament or particles from the composite, the filament or particles having a size suitable for use in additive manufacturing;
wherein in the absence of the carbon nanotubes a melt viscosity of the crystalline or semi-crystalline polymer is below 100 Pa·s, preventing its use in additive manufacturing.

2. The method of claim 1, wherein the carbon nanotubes are multi-walled carbon nanotubes.

3. The method of claim 1, wherein the carbon nanotubes are single-walled carbon nanotubes.

4. The method of claim 1, wherein the carbon nanotubes are double-walled carbon nanotubes.

5. The method of claim 1, wherein the carbon nanotubes are conducting, semiconducting, or combinations thereof.

6. The method of claim 1, wherein the carbon nanotubes are conducting.

7. The method of claim 1, wherein the carbon nanotubes are semi-conducting.

8. The method of claim 1, wherein the crystalline or semi-crystalline polymer is a polyester.

9. The method of claim 1, wherein the composite has a melt viscosity in a range from about 1,000 to about 5,0000 Pa·s.

10. The method of claim 1, wherein the crystalline or semi-crystalline polymer has a melting temperature less than about 250° C.

11. A composite comprising about 5 weight percent to about 25 weight percent of carbon nanotubes and a crystalline or semi-crystalline polymer;
wherein in the absence of the carbon nanotubes a melt viscosity of the crystalline or semi-crystalline polymer is below 100 Pa·s, preventing its use in additive manufacturing; and
wherein the composite has a melt viscosity in a range from about 1000 to about 50000 Pa·s.

12. The composite of claim 11, wherein the composite is formed into a filament having a diameter suitable for fused deposition modeling.

13. The composite of claim 11, wherein the composite is formed into particles having a size suitable for selective laser sintering.

14. The composite of claim 11, wherein the crystalline or semi-crystalline polymer comprises an ester.

15. The composite of claim 11, crystalline or semi-crystalline polymer comprises a copolymer.

16. A method of additive manufacturing comprising:
providing a filament or particle comprising a composite, the composite comprising:
about 5 weight percent to about 25 weight percent of carbon nanotubes; and
a crystalline or semi-crystalline polymer;
wherein in the absence of the carbon nanotubes a melt viscosity of the crystalline or semi-crystalline polymer is below about 100 Pa·s, preventing its use in additive manufacturing; and
heating the filament or particle as part of an additive manufacturing process.

17. The method of claim 14, wherein the additive manufacturing process is fused deposition modelling.

18. The method of claim 14, wherein the additive manufacturing process is selective laser sintering.

19. The method of claim 14, wherein the heating step is performed by a heating portion of an additive manufacturing apparatus.
